(19) United States
(12) Patent Application Publication
(10) Pub. No.: US 2014/0116577 A1
(43) Pub. Date: May 1, 2014

(54) METHOD OF PRODUCTION OF RARE EARTH MAGNETIC ALLOY RIBBON

(71) Applicants: Noritsugu SAKUMA, Toyota-shi (JP); Hidefumi KISHIMOTO, Toyota-shi (JP); Mikiya NOZAKI, Toyota-shi (JP)

(72) Inventors: Noritsugu SAKUMA, Toyota-shi (JP); Hidefumi KISHIMOTO, Toyota-shi (JP); Mikiya NOZAKI, Toyota-shi (JP)

(73) Assignee: TOYOTA JIDOSHA KABUSHIKI KAISHA, Toyota-shi (JP)

(21) Appl. No.: 14/064,948

(22) Filed: Oct. 28, 2013

(30) Foreign Application Priority Data
Oct. 29, 2012 (JP) 2012-238147

(51) Int. Cl. H01F 41/02

(52) U.S. Cl. CPC H01F 41/02
USPC 148/538

(57) ABSTRACT

Method of producing a rare earth magnetic alloy ribbon by rapid solidification using a rotary roll comprising: a step of preparing a rare earth magnetic alloy melt inside of a nozzle which faces said rotary roll, a step of applying a discharge pressure to said rare earth magnetic alloy melt in said nozzle, and a step of causing the discharge pressure to fall from a value at the time of start of discharge to a value which is required for sustained discharge at the instant that said rare earth magnetic alloy melt starts to be discharged from said nozzle. Preferably, the discharge pressure which is loaded on the melt surface inside the nozzle is made to increase from the sustained discharge pressure in accordance with the decrease in the amount of melt in the nozzle.

### TECHNICAL FIELD

The present invention relates to a method of producing a ribbon of a rare earth magnetic alloy by rapid solidification using a rotary roll.

### BACKGROUND ART

Rare earth magnets such as neodymium magnets (Nd₂Fe₁₄B) are high in flux density and extremely powerful so are being used as permanent magnets in various applications. To obtain excellent magnetic characteristics, it is necessary to stably secure a fine structure comprised of nanosize crystal grains. For this reason, for example, as disclosed in PLT 1, the method has been used of forming a ribbon (rapidly cooled ribbon) by causing rapid solidification by the single roll method etc. of discharging a melt of an alloy having the composition of the rare earth magnet from a nozzle to a cooling medium comprised of the surface of a rotary roll.

However, in the process of rapid solidification of an alloy melt, it is difficult to stably obtain a constant cooling rate, so there were the problems that it was not possible to stably obtain the desired nanocrystal grain structure, the cooling rate became excessive resulting in amorphous structures, the cooling rate became insufficient resulting in formation of a coarse crystal grain structure, and mixed structures of these ended up being formed, so excellent magnetic characteristics could not be stably secured.

### CITATIONS LIST

### Patent Literature

PLT 1: Japanese Patent No. 4179756

### SUMMARY OF INVENTION

### Technical Problem

The present invention has as its object to provide a method of producing a rare earth magnetic alloy ribbon of a suitable solidified structure which can realize excellent magnetic characteristics by controlling the discharge rate of melt to the roll surface in rapid solidification using a rotary roll.

### Solution to Problem

To achieve the above object, according to the present invention, there is provided a method of producing a rare earth magnetic alloy ribbon by rapid solidification using a rotary roll, the method of producing a rare earth magnetic alloy ribbon comprising:
a step of preparing a rare earth magnetic alloy melt inside of a nozzle which faces the rotary roll,
a step of applying a discharge pressure to the rare earth magnetic alloy melt in the nozzle, and
a step of causing the discharge pressure to fall from a value at the time of start of discharge to a value which is required for sustained discharge at the instant that the rare earth magnetic alloy melt starts to be discharged from the nozzle.

### Advantageous Effects of Invention

According to the present invention, the discharge pressure which is applied to the melt surface in the nozzle is made to drop from the large initial pressure which is required for the start of discharge to a sustained discharge pressure which is required for the sustained discharge period at the instant when discharge starts so as to enable the formation of a nanosize (tens of nm or less) fine crystal grain structure which is required for manifestation of excellent magnetic characteristics.

### BRIEF DESCRIPTION OF DRAWINGS

FIG. 1 is a view of the layout of a single roll type rapid solidification system for performing the method of the present invention.

FIG. 2 is a graph which shows a relationship between a discharge time and a discharge rate due to control of the present invention.

FIG. 3 gives SEM images which show the solidified structure of the cross-section of an alloy ribbon according to (1) the prior art and (2) Example 1. In the figure, “C” shows a contact side with the roll.

FIG. 4 is a graph which shows a relationship between a discharge time and a discharge pressure in a comparative example according to the prior art and Example 1 and Example 2 according to the present invention.

FIG. 5 gives SEM images which show the solidified structure of the cross-section of an alloy ribbon which is formed in the end stage of discharge in (1) Example 1 and (2) Example 2. In the figure, “C” shows a contact side with the roll.

### DESCRIPTION OF EMBODIMENTS

In a liquid rapid cooling system which performs the single roll method etc., the melt which is discharged on the rotary roll surface is stretched in an elongated tape shape along the outer circumference of the roll along with rotation of the roll and is rapidly cooled and solidified by being robbed of heat at the roll surface resulting in a rapidly cooled ribbon (thickness of tens of μm or so). This ribbon is peeled off from the roll surface without being able to follow the circular path of the roll circumference, advances in the tangential direction of the roll circumference, strikes the cooling plate and is broken into short fragments (length of several mm or so) which are then collected.

The cooling rate at the time of solidification, which determines the solidified structure of the rapidly cooled ribbon, depends on the volume of the melt tape which contacts the roll surface, that is, the discharge rate of the melt from the nozzle, if the amount of heat robbed by the roll surface is constant. The discharge rate of the melt depends on the gas pressure (discharge pressure) which is applied to the melt surface in the nozzle. At the melt which passes through the narrowly constricted discharge port from the nozzle body, its own surface tension and viscosity act as resistance. The initial resistance which acts at the time of the start of discharge is large. A large discharge pressure which overcomes this is required. On the other hand, if the sustained discharge state is reached after the start of discharge, the discharge resistance greatly falls. The relationship is similar to the relationship between the static frictional force and the dynamic frictional force.

However, in the past, a pressurized system was used which raised the pressure of the Ar or other gas which was stored in the surge tank and ejected it all at once, so the large initial discharge pressure at the time of start of discharge was maintained as is even in the sustained discharge state. Therefore, in the steady state, the discharge pressure became excessive compared with the suitable value for maintaining stable discharge and as a result there were the problems that the discharge rate became excessive, the thickness of the melt tape increased, the melt splattered without forming a continuous rapidly cooled ribbon, coarse crystal grains increased, and the magnetic characteristics fell.

In particular, when the nozzle material is low in reactivity with the rare earth alloy melt and low in wettability, since the initial resistance due to the surface tension is large, the initial discharge pressure has to be made extremely large, so the above problems became even more conspicuous.

On the other hand, it is important that the nozzle not react with the rare earth magnetic alloy melt from both the standpoints of prevention of melt loss and prevention of melt contamination. For example, an NdFeB-based composition rare earth magnetic alloy melt is desirable since it is high in affinity with oxygen, high in wettability with an Al₂O₃ or other oxide-based material, and small in discharge pressure, but at the same time has the detects that it is also high in reactivity with the nozzle, so is susceptible to melt loss of the nozzle and contamination, of the melt. Conversely, a non-oxide-based, for example, BN or other nitride-based, material is desirable in that it is low in reactivity with the above melt and is not susceptible to nozzle melt loss or melt contamination, but is low in wettability, so is large in initial resistance and requires a large discharge pressure at the time of start of discharge. This is far above the discharge pressure required for sustained discharge state, so the problem of the excessive discharge rate and the drop in magnetic characteristics due to the formation of coarse grains becomes greater.

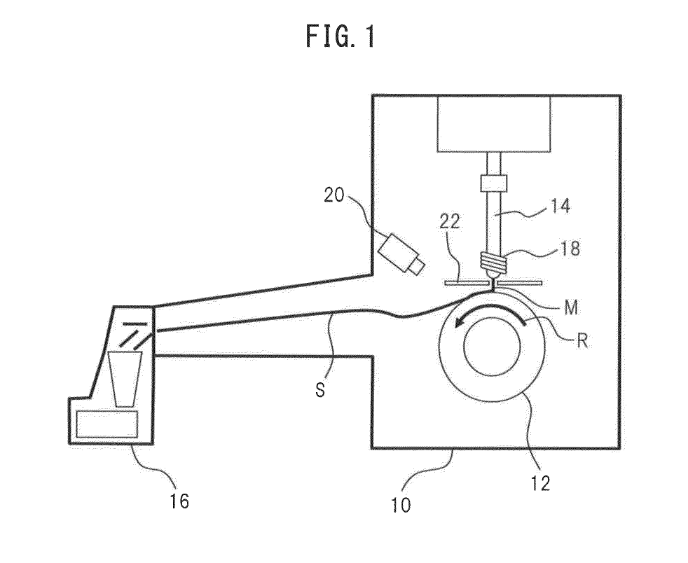

FIG. 1 is a cross-sectional view of a single roll type rapid solidification system for producing the rare earth magnetic alloy ribbon according to the present invention. A water cooled CU roll 12 which is arranged inside of a vacuum chamber 10 rotates in an R-direction about a horizontal shaft. Above the outer circumferential surface of the roll 10, a nozzle 14 is vertically arranged. Melt M of a rare earth magnetic alloy is discharged from a discharge port (not shown) which opens at a bottom end of the nozzle 14 on the rotating roll surface and forms an elongated tape shape of a width of several mm along with rotation R of the roll 14.

The tape shaped melt is robbed of heat powerfully at the water cooled roll surface and thereby rapidly cooled and solidified to form a ribbon S of a thickness of tens of nm. This is peeled off from the roll surface and advances in a substantially tangential direction to the roll outer circumference, strikes a cooling plate inside a recovery mechanism 16 which is shown at a left end of the figure where it is broken, and is recovered as fragments of a length of several mm.

The melt inside of the nozzle 14 is heated to a predetermined temperature by a high frequency heating coil 18. The temperature of the discharged melt M is continuously monitored by an infrared camera 20. A high frequency shield plate 22 prevents the high frequency heating coil 18 from unnecessarily heating the roll surface.

The present invention is a method of producing a rare earth magnetic ribbon using the system of FIG. 1. By adjusting the discharge pressure which is applied to the melt surface inside the nozzle 14, the discharge rate is suitably controlled to stably produce a ribbon of a solidified structure comprised of nanosize (typically tens of nm or less) fine crystal grains.

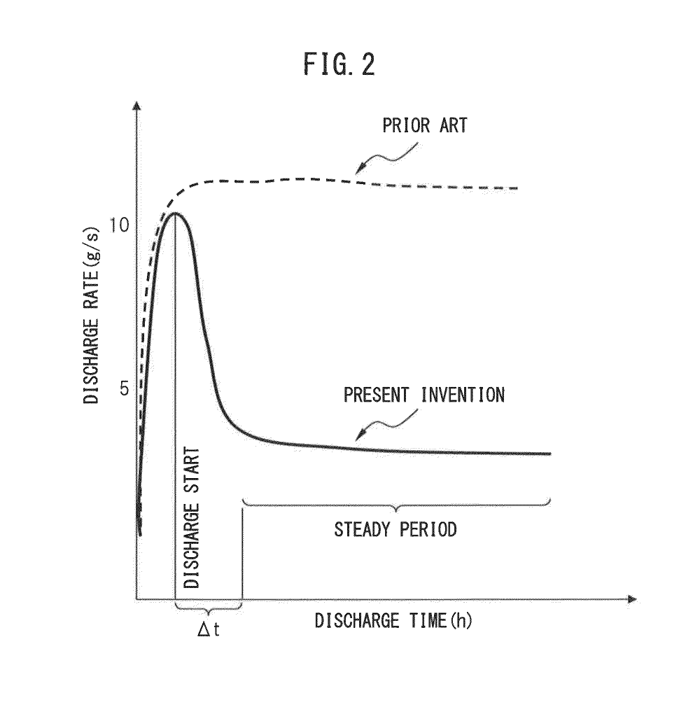

FIG. 2 schematically shows a relationship between the discharge time and the discharge rate according to the prior art and the method of the present invention. In the prior art, as shown by the broken line curve in the figure, the pressure was maintained constant at the initial discharge rate from the start of discharge throughout the entire period of discharge. As opposed to this, in the present invention, the discharge pressure which is applied to the melt surface inside of the nozzle 14 to make the rare earth magnetic alloy melt M be discharged from the nozzle 14 to the roll surface, as shown in FIG. 2 by the solid line curve, is caused to drop from the initial pressure at the instant when discharge is started and is made a sustained discharge pressure which is suitable for sustained discharge whereby a solidified structure which is comprised of nanosize fine crystal grains is obtained. As shown in FIG. 2, in the present invention, there is a time lag (Δt) which is required for the drop in pressure from the start of discharge to the period of sustained discharge. This is preferably as small as possible for improvement of the capacity of the system.

As explained above, the initial discharge pressure is larger compared with the discharge pressure which is required for the period of sustained discharge where the melt which is discharged from the nozzle forms a stable tape shape on the roll surface. For this reason, if leaving the initial discharge pressure as is for discharge in the period of sustained discharge, the discharge rate will become excessive and the cooling rate will become slower, so a solidified structure which is comprised of nanosize fine crystal grains cannot be obtained and coarse crystal grains will be formed. Further, excessively discharged melt sometimes bounces off the roll surface and splatters. In that case, the heat robbing action by the roll surface does not function at all and the melt is just naturally cooled, so the cooling rate becomes further slower and granular drops which are comprised of coarse crystal grains are formed.

According to the present invention, the discharge pressure which is applied to the melt surface inside of the nozzle 14 is made to fall from the initial pressure at the instant when discharge is started so as to make it the sustained discharge pressure which is suitable for sustained discharge. By lowering the pressure from the large initial pressure to the sustained discharge pressure at the instant of start of discharge, the discharge rate is controlled to a suitable value, a solidified structure which is comprised of nanosize fine crystal grains is obtained, and a rare earth magnetic alloy ribbon which is provided with high magnetic characteristics (coercivity and rectangularity) is obtained.

In a preferable embodiment, the discharge pressure which is applied to the melt surface inside of the nozzle 14 is made to increase from the sustained discharge pressure in accordance with a decrease in the amount of melt inside of the nozzle.

At the end stage of the discharge period, the amount of melt inside the nozzle decreases and the amount of contribution of the weight of the melt itself to the discharge pressure falls. If the discharge pressure falls and the discharge rate becomes insufficient, the amount of melt which solidifies on the roll surface (thickness of melt tape) will decrease, the cooling rate will become excessive, and amorphous structures will be formed. In a preferred embodiment, the formation of amorphous structures at the end stage of discharge is prevented to secure a solidified structure which is comprised of nanosize fine crystal grains. Due to this, a uniform ribbon (rapidly cooled ribbon) is obtained from the start of discharge to the end stage of discharge and the material yield is improved.

When increasing the discharge pressure at the end stage of discharge according to the above preferred embodiment, the final increase in pressure is preferably 0-50 kPa or so, more preferably 0-30 kPa. Due to this, the controlled discharge rate is preferably 10 g/sec or more, more preferably 6 g/sec or less. However, if the discharge rate is too small, the cooling rate will become too fast and the solidified structure will become amorphous or the melt will solidify at the discharge port resulting in clogging of the nozzle, so 1 g/sec or more is desirable. For this reason, when raising the sustained discharge pressure at the end stage of discharge, the pressure is preferably raised in a range where the final sustained discharge pressure does not exceed 50 kPa.

### EXAMPLES

### Comparative Example

An Nd_{14.7}Fe_{79.03}B_{5.67}Ga_{0.3}Cu_{0.1}Al_{0.2} composition rare earth magnetic alloy was produced in an arc melting furnace. The single roll type rapid solidification system of FIG. 1 was used to produce a rapidly cooled ribbon under the conditions of Table 1. According to the prior art, when the melt temperature reached a predetermined temperature, pressure was applied to the surge tank to raise it to the pressure of the start of discharge. That pressure was held as is until the end of discharge.

TABLE 1

| | |
|---|---|
| Nozzle material | Quartz and silicon nitride |
| Nozzle aperture | 0.6 mm |
| Distance from roll surface | L = 5 mm |
| Discharge pressure | Hold constant at initial pressure at time |
| | of start of discharge |
| Chamber pressure | −65 kPa |
| Roll peripheral speed | 20 m/s |
| Roll temperature | 15° C. |
| Melting temperature | 1450° C. |

### Example 1

Nd_{14.7}Fe_{79.03}B_{5.67}Ga_{0.3}Cu_{0.1}Al_{0.2} composition rare earth magnetic alloy was produced in an arc melting furnace. The single roll type rapid solidification system of FIG. 1 was used to produce a rapidly cooled ribbon under the conditions of Table 2. According to the present invention, when the melt temperature reached a predetermined temperature, pressure was applied to raise it to the pressure of the start of discharge. At the instant of the start of discharge, the pressure was lowered to the sustained discharge pressure (−50 kPa: gauge pressure*). The rest of the conditions were the same as in the comparative example. (*Gauge pressure . . . shown by difference from atmospheric pressure (1 atm))

TABLE 2

| | |
|---|---|
| Nozzle material | Quartz and silicon nitride |
| Nozzle aperture | 0.6 mm |
| Distance from roll surface | L = 5 mm |
| Discharge pressure | Lower from initial pressure to sustained |
| | discharge pressure (−50 kPa) at instant |
| | of start of discharge |
| Chamber pressure | −65 kPa |
| Roll peripheral speed | 20 m/s |
| Roll temperature | 15° C. |
| Melting temperature | 1450° C. |

TABLE 3

| | | Discharge | Sustained | | | |
|---|---|---|---|---|---|---|
| | | start | discharge | Discharge | | Coer- |
| | Nozzle | pressure | pressure | rate | Melt | civity |
| | material | (kPa) | (kPa) | (g/sec) | splatter | (kOe) |
| Comp. | Quartz | 50 | 50 | 7 | Some | 19.0 |
| ex. | Silicon | 150 | 50 | 15 | Yes | 16.5 |
| | nitride | | | | | |
| Ex. 1 | Quartz | 50 | 15 | 2.5 | No | 20.5 |
| | Silicon | 150 | 15 | 2.5 | No | 21.0 |
| | nitride | | | | | |

### Evaluation of Results

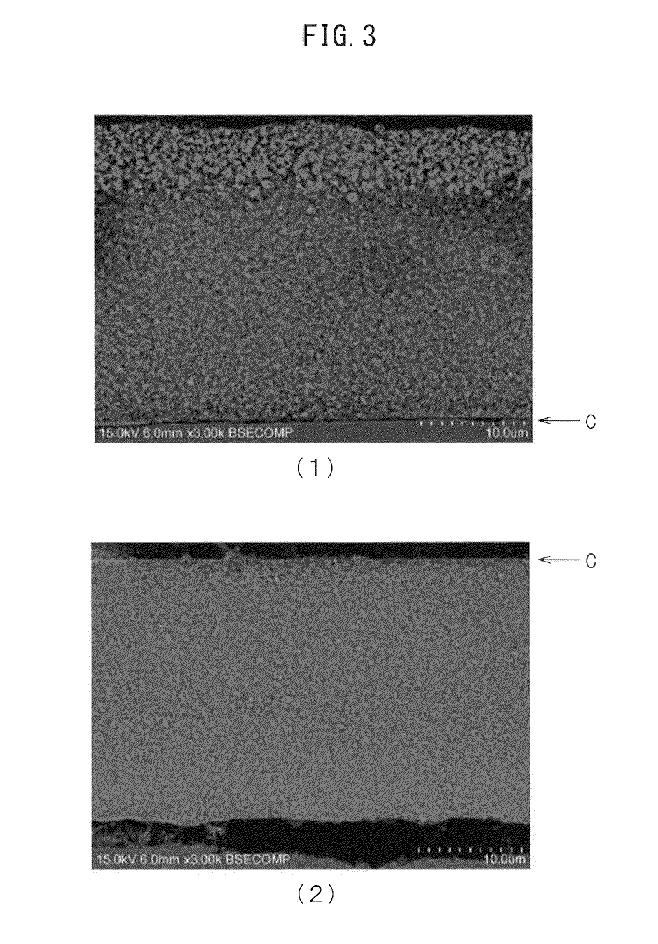

Table 3 shows the results of the comparative example and Example 1 together. In the comparative example, in accordance with the prior art, the large initial discharge pressure of the time of start of discharge was held as is throughout the entire period of discharge, so the discharge rate became excessive and melt splatter was observed. Further, as shown in FIG. 3(1), the solidified structure was a coarse crystal structure of a crystal grain size of 1 μm to several μm. A nanosize (tens of nm or less) fine structure could not be obtained. As a result, as shown at the right end of Table 3, the coercivity was a low value of less than 20 kOe.

As opposed to this, Example 1 of the present invention lowers the large initial discharge pressure to the sustained discharge pressure at the instant of the start of discharge so as to control the discharge rate to a suitable value, so no melt splatter occurred. Further, as shown in FIG. 3(2), the solidified structure had a crystal grain size of about 30 nm. A nanosize fine structure was obtained. As a result, as shown at the right end of Table 3, the coercivity was improved to a value exceeding 20 kOe.

In this way, by suitably controlling the discharge rate in accordance with the present invention, a nanosize fine crystal structure is obtained and the coercivity is improved regardless of the nozzle material.

Note that, depending on the nozzle material, the discharge start pressure differs because, as explained above, a melt of an NdFeB-based rare earth magnetic alloy is good in reactivity and high in wettability with an oxide (Al₂O₃) quartz nozzle, so is low in discharge resistance, while is low in reactivity and low in wettability with a silicon nitride (SiN) nozzle, so is high in discharge resistance.

Basically, from the viewpoint of preventing melt loss of the nozzle and contamination of the melt, the nozzle material is preferably low in reactivity with the melt. In this case, the wettability becomes lower and a large initial discharge pressure becomes necessary, but by employing the method of the present invention, it is possible to suitably control the discharge rate during the discharge period even if the initial discharge pressure is large.

### Example 2

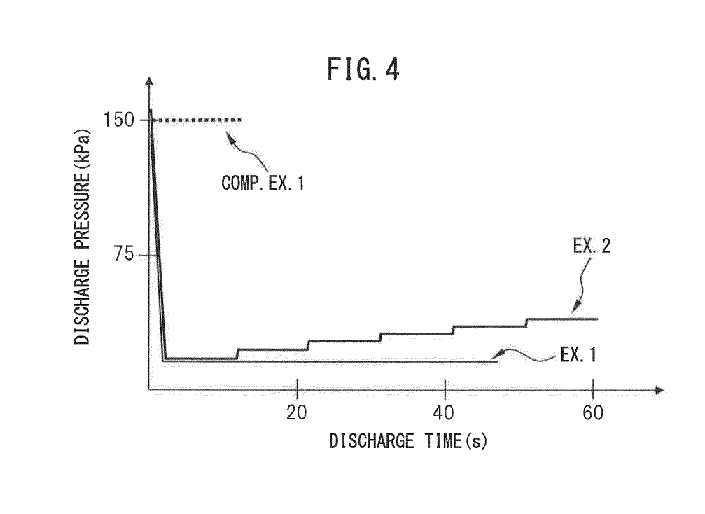

An Nd_{14.7}Fe_{79.03}B_{5.67}Ga_{0.3}Cu_{0.1}Al_{0.2} composition rare earth magnetic alloy was produced in an arc melting furnace. The single-roll type rapid, solidification system of FIG. 1 was used to produce a rapidly cooled ribbon under the conditions of Table 4. As the nozzle material, only the single type of silicon nitride was used. According to the present invention, when the melt temperature reached a predetermined temperature, the pressure was increased to raise the pressure to the discharge start pressure and, at the instant of the start of discharge, the pressure was caused to lower to the sustained discharge pressure (−50 kPa). After this, according to a preferred embodiment of the present invention, the discharge pressure was slowly raised in a step manner in accordance with the balance of melt in the nozzle at a rate of 5 kPa/10 sec. The rest of the conditions were the same as in Example 1. FIG. 4 shows by comparison the change in the discharge pressure with respect to the discharge time for Example 1 and Example 2.

TABLE 4

| | |
|---|---|
| Nozzle material | Silicon nitride |
| Nozzle aperture | 0.6 mm |
| Distance from roll surface | L = 5 mm |
| Discharge pressure | Lower from initial pressure to sustained |
| | discharge pressure (−50 kPa) at instant |
| | of start of discharge then gradually |
| | raise in accordance with balance of melt |
| | in nozzle (+85 kPa -> 50 kPa -> −25 kPa) |
| Chamber pressure | −65 kPa |
| Roll peripheral speed | 20 m/s |
| Roll temperature | 15° C. |
| Melting temperature | 1450° C. |

### Evaluation of Results

Table 5 shows together the results in the case where the nozzle material of Example 1 is made silicon nitride and the results of Example 2.

TABLE 5
(Nozzle Material: Silicon Nitride)

| | Sustained | | | Formation | | |
|---|---|---|---|---|---|---|
| | discharge | Discharge | Discharge | of | Coer- | |
| | pressure | rate | time | amorphous | civity | |
| | (kPa) | (g/sec) | (sec) | structures | (kO3) | Yield* |
| Ex. 1 | 15 | 2.5 | 45 | Yes | 21.0 | 72 |
| Ex. 2 | 15 −> 40 | 2.5 | 62 | None | 21.0 | 94 |

(*Yield: Ratio of amount of melt which could be discharged with respect to amount of melt in nozzle which was initially charged)

In these Examples 1 and 2, the amount of melt was 150 g or a laboratory scale, so soon after the sustained discharge state was reached (about 10 sec from start of discharge), the remaining amount of melt started to have an effect on the discharge pressure. In Example 2, the discharge pressure was slowly raised in accordance with this from 15 kPa at a rate of 5 kPa/10 sec in steps. Due to this, over the entire discharge period, a substantially constant discharge rate could be maintained and the melt which was initially charged into the nozzle could be discharged substantially completely. Even so, the yield was 94%. It did not reach 100% since melt remained stuck to the inside walls of the nozzle as dross.

However, it is learned that Example 2 is greatly improved compared with Example 1. In Example 1, discharge was continued as is at a low pressure, so the drop in the discharge rate in the middle caused the nozzle to clog and discharge was stopped. As a result, the yield was a low 72%.

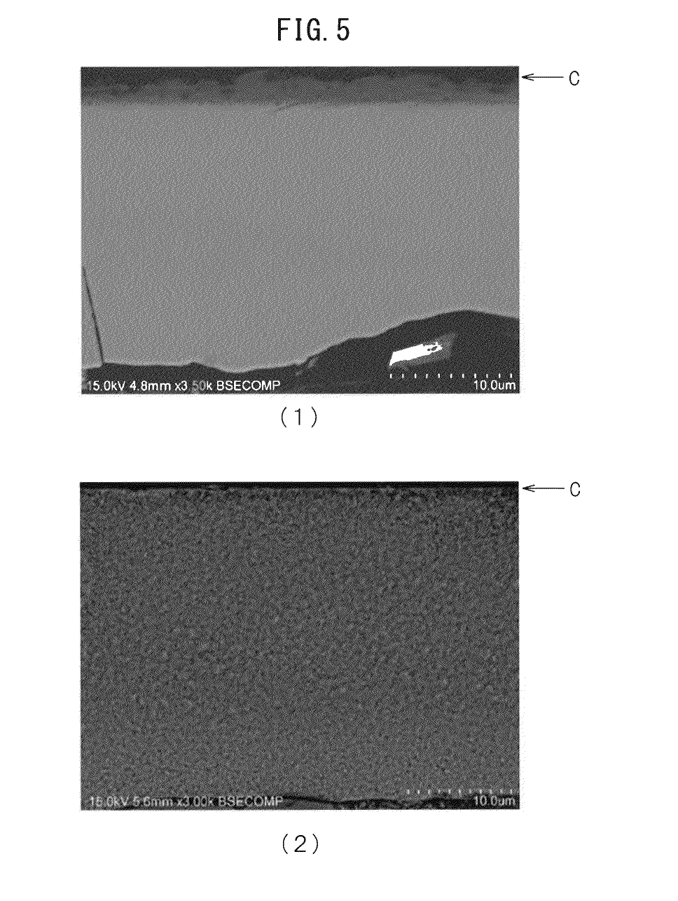

Further, the drop in the discharge rate also had a remarkable effect on the solidified structure. As shown in FIG. 5(1), in Example 1, the drop in the discharge rate led to the cooling rate becoming too fast and the solidified structure at the end stage of discharge forming amorphous structures. The amorphous structure parts ended up falling in coercivity as well. The values which are given in Table 5 are values for parts minus the amorphous parts at the end stage of discharge.

The solidified structure of Example 1 was formed with amorphous structures, while the solidified structure of Example 2 was a fine crystal structure of a grain size of 30 nm or so as shown in FIG. 5(2) even at the end stage of discharge. Even viewed from the magnetic characteristics, the yield became high.

Note that, in the present example, as explained above, the initial amount of melt was 150 g or a laboratory scale, so when lowering the discharge pressure from the high value at the time of start of discharge to the low value of the sustained discharge state and holding this value for about 10 sec, the remaining amount of melt in the nozzle already started to have an effect on the discharge pressure. However, at the actual production scale, the initial amount of melt is a large amount on the order of several kilograms or more, so the decrease in the balance of melt in the nozzle starts to have an effect on the discharge pressure after a longer time elapses. This may be after for example holding for 30 minutes or more or further 45 minutes or more in the state of lowered discharge pressure.

### INDUSTRIAL APPLICABILITY

According to the present invention, there is provided a method of producing a rare earth magnetic alloy ribbon of a suitable solidified structure which can realize excellent magnetic characteristics by controlling the discharge rate of melt to the roll surface in rapid solidification using a rotary roll.

What is claimed is:

1. A method of producing a rare earth magnetic alloy ribbon by rapid solidification using a rotary roll comprising:
a step of preparing a rare earth magnetic alloy melt inside of a nozzle which faces said rotary roll,
a step of applying a discharge pressure to said rare earth magnetic alloy melt in said nozzle, and
a step of causing the discharge pressure to fall from a value at the time of start of discharge to a value which is required for sustained discharge at the instant that said rare earth magnetic alloy melt starts to be discharged from said nozzle.

2. The method of producing a rare earth magnetic alloy ribbon in claim 1, further comprising maintaining said discharge pressure at a constant level or more after causing said discharge pressure to fall.

3. The method of producing a rare earth magnetic alloy ribbon in claim 1, further comprising making said discharge pressure increase in accordance with the decrease in the rare earth magnetic alloy melt in said nozzle after causing said discharge pressure to fall.

4. The method of producing a rare earth magnetic alloy ribbon in claim 1, further comprising causing said discharge pressure to fall to 15 kPa in said step of causing the discharge pressure to fall.

5. The method of producing a rare earth magnetic alloy ribbon in claim 1, further comprising maintaining said lowered pressure for 10 sec or more after causing said discharge pressure to fall.
